(19) United States
(12) Patent Application Publication
(10) Pub. No.: US 2004/0078210 A1
(43) Pub. Date: Apr. 22, 2004

(54) Internet air travel system

(76) Inventor: Robert S. Segelbaum, Laguna Woods, CA (US)

Correspondence Address: CISLO & THOMAS, LLP, 233 WILSHIRE BLVD, SUITE 900, SANTA MONICA, CA, 90401-1211, US

(21) Appl. No.: 10/279,137

(22) Filed: Oct. 22, 2002

(51) Int. Cl. G06F 17/60

(52) U.S. Cl. 705/1; 705/5

(57) ABSTRACT

An Internet Air Travel System that enables the utilization of excess seating capacity on commercial aircraft to transport passengers in an economic manner along region-to-region route-corridors as opposed to along specific routes or itineraries and whereby said transportation takes place at an indefinite moment within a window or interval of time as opposed to at a specific time.

### COPYRIGHT AUTHORIZATION

A portion of the disclosure of this patent document contains material which is subject to copyright protection. The copyright owner has no objection to the facsimile reproduction by any one of the patent disclosure as it appears in the U.S. Patent and Trademark Office patent files or records, but otherwise reserves all copyright rights whatsoever.

### FIELD OF THE INVENTION

This invention relates to an INTERNET AIR TRAVEL SYSTEM and its unique applicability to enable a specific type of traveler to take advantage of unoccupied seating capacity in departing commercial aircraft and to increase revenue of airlines.

### BACKGROUND OF THE INVENTION

In today's world air-transportation environment, the flying public has generally become accustomed to making reservations either through agents or themselves via phone and, more recently, the Internet, to obtain passage on commercial aircraft that meet exacting standards with respect to the timing and itinerary requirements of the individual traveler.

However, for the airlines to meet travelers' rigid and specific timing/itinerary requirements, which are often unnecessary for a certain class of traveler making a certain type of trip, they have had to put far more seats in the air than can be filled by the demand, and, therefore, significantly overprice airfares in order to recover their operating costs and operate at a profit.

But there is, at any given moment, a sizable segment of the population which includes but is not limited to such subgroups as college students and retired people that does not need to travel under rigid time or itinerary constraints along certain given high-volume route-corridors and thus are unduly burdened with having to pay the high costs of what may be considered conventional air passage.

With the herein-disclosed system, the shortcomings of the aforementioned air travel environment are overcome by an entirely Internet-driven process whereby the air traveler who does not demand a specific set of time/itinerary requirements so that he may travel at the lowest possible cost, at the same time enabling the airline to obtain revenue from a seat that would otherwise be unoccupied and produce no revenue. In other words, the methodology presented herein presents a win/win situation for both parties to the sale/purchase of an airplane seat, assuming that both parties, air-transport provider and passenger, are willing to make certain concessions. The respective concessions are, on the part of the traveler, flexibility with respect to timing and itinerary and willingness to live with a bit of advance uncertainty as to specifics, and, on the part of the airline, flexibility with respect to the amount of revenue it could expect to derive from the seat, given that no seat is committed or promised in advance of departure to any given passenger.

Since the inception of commercial passenger aviation on long-haul corridors, huge numbers of seats in commercial aircraft have flown dead empty, bringing no value or benefit to the operators of the aircraft, and resulting in dead financial loss since the cost incurred to put these seats in the air cannot be recovered. Based on the U.S. DOT's Bureau of Transportation Statistics figures for 2001, it can be estimated that a minimum of roughly 1.8 million seats fly empty across the North Atlantic alone in a given year. Valued at a liquidity price of 100 dollars per seat, this represents a lost revenue figure of 180 million dollars—and this figure ONLY applies to the North Atlantic.

The herein-disclosed system enables a system-provider to perform precisely the function described above: to make possible and practical the sale of transportative capacity in long-haul commercial aircraft to the public at the last possible moment before that capacity perishes valueless, and thereby empower a certain type of buyer to purchase a product which he would not otherwise be willing to purchase because of too much uncertainty, and which would not otherwise be saleable, from the carrier's point of view, without causing a risk of lost revenues from higher-revenue-paying passengers.

This capability makes it possible to reduce losses due to unutilized capacity in departing aircraft, and if widely applied, would significantly reduce the number of empty seats flying across long-haul corridors and the dead losses incurred by having those seats empty. And the recent broad-based public acceptance of the Internet and cybercommunications as a legitimate form of human interaction has made possible the significant enhancement and extension of this capability via the disclosed invention.

### SUMMARY OF THE INVENTION

An Internet air travel system comprising the publicizing and advertising to, or recruitment of, a select group of travelers especially including but not limited to college students and retired individuals who do not require promises of specific, precise timings or itineraries for a given instance of travel, and providing indoctrination to those travelers in the group detailing the general aspects of the system and the ultimate goal of the system with respect to economic savings. An Internet screening process is utilized in order to select interested travelers predicated on selected parameters and thereafter registering them for use of the system by receiving authorization, via the Internet, for a monetary payment via credit card. The system-provider establishes and maintains a constantly updated database of air travel schedules and availabilities and is thus able to determine probable vacancy rates on airplanes that fly the schedules. There is established by the system-provider via the Internet a constantly open channel of communication between the registered users of the system and the system-provider which enables and facilitates the gathering and transmission of the real-time data and information necessary to enable the registered user to utilize the air-transport system to economic advantage to board an airplane that is departing at an indefinite point during a generic time-window, to take the passenger along a generic itinerary of benefit in conveying that passenger to or toward where he wishes to go.

### OBJECTS OF THE INVENTION

It is an object of the present invention to provide an Internet air travel system that appeals to a specific type or class of traveler.

It is another object of the present invention to provide a unique Internet air travel system that allows both the traveler and airline using the system to enter into a relationship by which each realizes a benefit which would not otherwise be realizable to either.

It is another specific object of the invention to provide an Internet air travel system which is variable so as to permit an air traveler to travel within a generic time frame or window as opposed to at a specific time and on a specific date, and to permit that traveler to be carried along a generic region-to-region route-corridor which benefits the traveler as opposed to along a specific point-to-point itinerary, and to permit the utilization of what would otherwise be an empty seat on the aircraft.

It is still another important object of the present invention to provide an Internet air travel system that provides economic benefit to both traveler and airline.

These and other objects and advantages of the present invention will become apparent from a review of the following specification and accompanying figures.

### BRIEF DESCRIPTION OF THE FIGURES

FIG. 1 is block diagram showing a general overview of the Internet air travel system of the invention.

FIG. 2 is a more detailed view, in flowchart form, of the methodology of the hereindisclosed invention, illustrating one of its central processes: the progress of a passenger through the system.

### DESCRIPTION OF THE PREFERRED EMBODIMENT(S)

The detailed description set forth below in connection with the appended figures of drawing is intended as a description of presently preferred embodiments of the invention and is not intended to represent the only forms in which the present invention may be constructed and/or utilized. The description sets forth the functions and the sequence of steps for constructing and operating the methodology of the invention in connection with the illustrated embodiments. However, it is to be understood that the same or equivalent functions and sequences may be accomplished by different embodiments that are also intended to be encompassed within the spirit and scope of the invention and would be covered by the appended claims.

A system and method are disclosed for use of the Internet to encourage a specific social or sociological type of traveler to position himself at the point of departure to purchase last-minute seating capacity on departing long-haul commercial aircraft, and also to facilitate the process by which the passenger positions himself for the boarding of such aircraft, and to enhance the probability that he will do so by minimizing the personal risk involved in such a course of action.

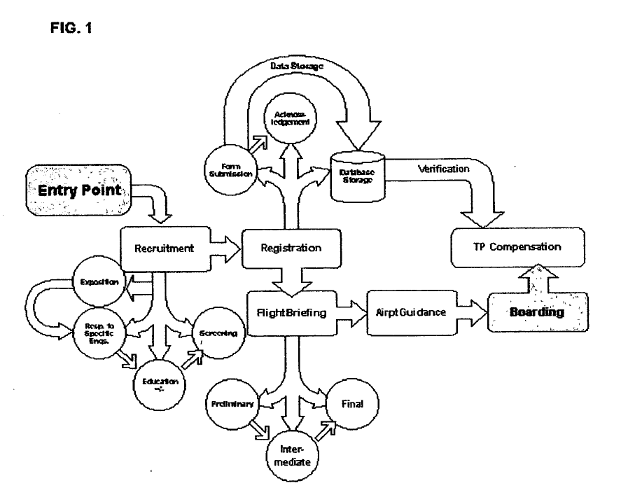

The disclosed system and the process it embodies as best seen in FIG. 1 starts with publicizing, advertising, and/or RECRUITMENT (REC) using the Internet. A certain ethos of unstructured exploratory travel is exposed, and introduced to the public. This is part of the social-psychological basis of the system, for it can function successfully only for this particular type of traveler. However, many persons who are within the category, for any given trip, may not realize that they are, so there is a certain consciousness-raising function required as part of this exposition.

Once passenger-recruitment is complete, the next step in the process is the REGISTRATION (REG) subprocess, which consists of (a) the transmittal of all necessary passenger information; (b) an indication of acceptance of the terms and conditions under which the system is made available and accessible to the user; and (c) the granting, by the user, of a general authorization to the merchant providing the system to collect payment from the passenger via instantaneous electronic means when and as such payment should become necessary. All registration information is stored in a central database for retrieval at departure time or on eve of departure by the merchant, for a variety of purposes, and an acknowledgement of registration is passed, via cyber technology, to the registrant in order to advise him that his registration has been processed and of his current status and the next steps he will be required to take in order to use the system.

Once registration is complete as noted above, the next step is the initiation, via cybercommunicational media, of the FLIGHT-BRIEFING (FB), the instructional and factual information necessary for the passenger to position himself to board a flight. The Flight-Briefing is divided into three parts or sections: the Preliminary Flight-Briefing (PFB), during which a very generic view of long-term upcoming availability is offered to the passenger, and instruction is given as to the various techniques that he may be called upon to employ in order to position himself; the Intermediate Flight-Briefing (IFB), which consists of a progressive refinement of the data provided in the PFB; and the FINAL FLIGHT-BRIEFING (FFB), which begins on or very close to the very day of departure, and terminates either when the user indicates (s)he has no further need of information or when (s)he sets foot on board a commercial jet aircraft departing across his/her desired route-corridor, or any subsequently-agreed-to route-corridor, whichever occurs first.

Once the passenger departs for the airport from which his attempted flight will be originating, the FFB continues into its AIRPORT SUBPHASE, with the aid of an AIRPORT SUPPORT PERSON, or ASP, a person socially proximate to the passenger who agrees to act as a communicational conduit between the online staff of the system-provider and the passenger should any problems arise in the boarding process. Normally, there are no problems, and the passenger simply boards his flight and departs. If problems should arise, however, the online staff are trained, as part of the disclosed system, to address these and, to the extent possible, solve them. This training itself takes place via cybercommunicational methods.

Concurrently with the recruitment and processing of passengers from the demand-side of the air-transportation market, the disclosed system processes information from the supply-side—i.e., transportation-providers (TPs), potential sellers of seats—as to the estimated capacities of upcoming flights, so as to maximize the chances of any particular passenger s success at gaining access to a commercial aircraft, optimize the placement of passengers on the TPs aircraft, and, thus, maximize the TP's return on investment. A variety of epistemological techniques and types of data are used to formulate the estimates of availability necessary to maximize the chances of a best-case outcome for the individual passenger, as well as for the TP, and to best “coach” the passenger in his formation of a “departure management strategy”, i.e., a set of decisions intended to optimize his travel outcome. A large proportion of the interaction between merchant and passenger and between merchant and airline is handled via a relatively new electronic communication technology powered by the Internet known as “Instant Messaging”—without which the disclosed system would not be possible due to time constraints. The rest is handled by electronic mail and the website, and ALL communication with the public is handled via the Internet, with as much as possible (that is, as much as the TPs will accept) of communication with the supply-side also handled via the Internet. The only communication not handled via the Internet is communication of an emergency nature, i.e., communication which if not handled in an extremely timely fashion when no cybercommunicational means is available, would result in users of the system not boarding aircraft in seats in which they otherwise would board.

Finally, after the successful termination or completion of the passenger's “air transport endeavor”, the passenger's payment is transferred to the transportation-provider. This transfer occurs completely via cyber as part of the disclosed system, and is costless.

A more complete understanding of the present invention, as well as further features and advantages of the present invention, will be obtained by reference to the following detailed description and diagrams or textual illustrations.

Glossary

As used herein, the following terms are defined to mean:

Airhitch®—a system/method/process/program in operation since 1969 which facilitates last-minute boarding of commercial jet aircraft by passengers whose concerns about the specifics of timing and itinerary are minimal.

Airhitch® Boarding Code (ABC)—a unique six-character autogenerated alphanumeric character-string associated with any given Airhitching endeavor (q.v.), which is assigned to and functions as an identifier of the Airhitchers (q.v.) performing the endeavor as bona fide Airhitchers with the eligibility and right to access a given aircraft upon departure provided that capacity is available on it at that moment, and also functions as an entitlement to such boarding.

Airhitch® Online Staff (AOS)—an aggregate of humans and machines providing, via the Internet to the public, the intellectual, informational, communicational, and educational material which informs all phases of the CyberAirhitch® system.

Airhitch® Operating Company (AOC)—a company which conducts the mercantile transactional functions of the system. Normally, this is also a merchant-operator or provider of the system.

Airhitcher—a user of the Airhitch® system for its intended purpose of covering as large a portion of the distance separating that user, as he resides at a given point on the earth, from some other given other point on the earth, at as low a cost possible and at minimal possible sacrifice of personal freedom of future movement.

Airhitching endeavor—an specific attempt by an Airhitcher (or grouping of Airhitchers intending to travel together) to use the Airhitch® system for its intended purpose as described above in the definition of Airhitcher (q.v.).

Airport Support Person (ASP)—a person with enough solidarity with the user of the Airhitch® system (friend, family member, etc.) recruited by the user to act as a transparent communicational conduit between the user voice-phoning from an airport and the Airhitch® Online Staff communicating via the Internet's “Instant Messaging” technology.

Exploratory travel—travel undertaken for its own sake, or purely for the sake of exploration, without externally constraining or motivating events or processes.

Flight-Briefing (FB)—an ongoing, intermittent and/or continuous interactive dialogue (series of verbal interactions) which occurs across the time between when a person registers to be a user of the Airhitch® system and the time he either (a) sets foot on a commercial aircraft departing across a route-corridor connecting two regions of his choosing, OR (b) indicates to the maintainers of the system that (s)he has no more need for such a dialogue.

Instant Messaging (IM)—the Internet technology related to immediate and instantaneous exchange of typewritten messages between Internet users across distance.

Region (specialized for Airhitch®-related use)—a geographic area containing numerous airports, all of which are reasonably accessible to each other via low-cost, unrestricted surface or air transportation.

Route-Corridor (RC)—a length of distance generically connecting all points in a given region with all points in another given region; to be contradistinguished from a ROUTE, which connects ONE SINGLE specific unique point in a region with one single specific unique point in another region or within the same region.

Transportation-provider (TP)—any person, company, or entity which assumes a role of financial risk-taking in the providing of air transportation and who controls, on any specific occasion of operation of one or more commercial jet aircraft capable of transporting passengers at least 2000 miles under national and international regulations, the movements of, and/or access to, that or those aircraft.

Unstructured travel—travel undertaken with a high value placed on freedom of movement and freedom from restriction thereupon.

The disclosed system (“CyberAirhitch®”) is for stimulating, receiving and processing requests for travel from a certain specific but large sector of the air-transport market which cannot be otherwise attracted, and for management of these requests in such a way as to position the traveler to become a buyer of surplus or distressed transportative capacity at or very near to the moment of perishability of said capacity.

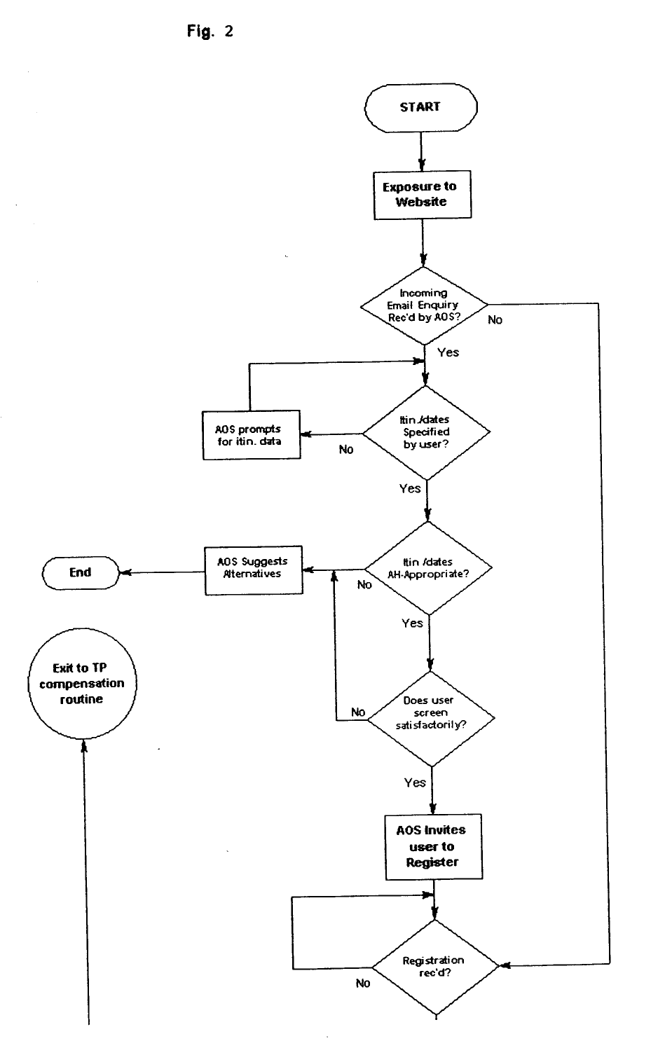

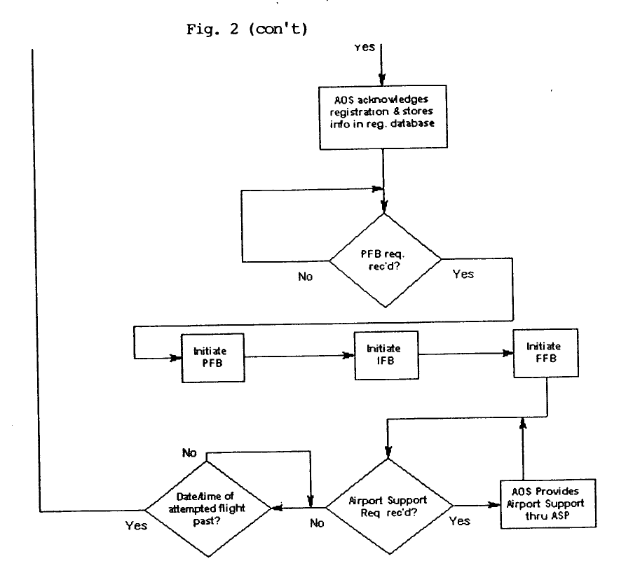

FIG. 2. shows in more detail the major components of the system. These components are presented in roughly their chronological order of deployment as a given CyberAirhitch® system-user passes into and through the system.

According to a feature of the present invention, a system of using cyber-communication, made possible in recent years by the technological advances and broad public acceptance of this form of communication by the global public, is disclosed that greatly enhances the workability of an already existing, but non-patentable (because in commercial use for more than one year), system for encouraging the positioning of a specific type of paying passenger to board departing commercial aircraft at the moment of seat-perishability, thus utilizing what would otherwise be unutilized and unutilizable product, and contributing REVENUE in return for that product where otherwise there would be none.

The type of paying passenger who can be encouraged and positioned as a user of CyberAirhitch® falls into one or more of the following categories (a) persons who have hitchhiked as part of their life experience; (b) persons who, though they may not have hitchhiked, have understood from friends or acquaintances or family-members who have hitchhiked the nature of the process; (c) persons who, though they may not have had prior exposure to hitchhiking, can be educated to such as a means for accomplishing low-cost, unstructured and unrestricted travel AND WHO HAVE A DESIRE OR NEED TO ENGAGE IN THIS TYPE OF TRAVEL; (d) persons with little or no external responsibility in their lives (typical among, but not limited to, youthful persons in the 18-24 age bracket and/or retired persons in good health). [It is estimated that there is a market of 22 million such persons, at any given instant (and the categories are dynamic, people move into and out of them with life circumstances and other events), in the USA alone, probably 5 million in Canada, and immeasurable millions in Europe. This market is a market classically NEGLECTED AND/OR IGNORED by typical airline-industry marketing schemata because the airline industry does not believe it possible to distinguish it from the market of high-paying, expense-account-oriented, financially-motivated BUSINESS PASSENGERS.]

Travelers or potential travelers displaying one or more of the above social attributes are referred to within the terminology of Airhitch® as “budget unstructured exploratory travelers” (BUETs). One of the objectives of the Airhitch® system is to convert as many BUETs as possible on as many possible occasions of travel as possible into AIRHITCHERS, so that they can fill up what would be otherwise unutilized capacity on commercial airplanes, thus eliminating waste and resulting in great economic savings for transportation providers and passengers alike, while at the same time not interfering with existing markets.

FIGS. 1 and 2 show the major components (further broken down into subcomponents where necessary) of the CyberAirhitch® system. These are largely self-explanatory, however the following considerations should be noted:

(a) EXPOSITION—this is the subcomponent of CyberAirhitch® which draws the attention of the public to the very existence of the system, and as such is integral to the system itself (since no system can function without users). Since the system is so new and radical in many ways, it is non-obvious even to travelers who would make great and profitable use of it. Since this is accomplished entirely via cyber-communication (i.e., the WorldWide Web), it stands apart generically from standard media advertising. In other words, it is purely “cyber”. A major source of visitors to the website is simply word-of-mouth: friends, relatives, and associates tell each other about it. Another source is random Web-searching. These two methods of Website visitor-production account for 99% of the visits to the site and, thus, 99% of entrances to the system.

(b) RESPONSE TO SPECIFIC ENQUIRIES—this is a sometimes-present/sometimes-absent subcomponent. Obviously if no enquiry is necessary, but the existence of the Airhitch® website satisfies all questions and prompts the visitor to system-entry without any need for making enquiry, then this subcomponent need not be deployed. [In fact one of the CyberAirhitch® SYSTEM-OBJECTIVES is to MINIMIZE the need for this component and MAXIMIZE the number of occurrences of NON-SUPPORTED SYSTEM ENTRY.]

(c) EDUCATION AS TO BENEFITS DRAWBACKS—this subcomponent becomes deployable and necessary as and when prospective CyberAirhitchers demonstrate a need to weigh the relative “pros and cons’ of CyberAirhitching (and, by implication, Airhitching). It contributes to the SCREENING process (the next subcomponent presented, in sequence) in the sense that it promotes SELF-SCREENING among potential CyberAirhitchers.

(d) SCREENING—this subcomponent takes place concurrently with the EDUCATION subcomponent described in (c) above. It includes the application of certain PSYCHOLOGICAL MEASURES and OTHER MEASURES to assess the potential “fit’ of a given prospective CyberAirhitcher's personality and lifestyle to the somewhat radical and heterodox nature of the Airhitch˜and CyberAirhitch® systems. The screening process can be likened roughly to the screening process employed by institutions of higher education to attempt to predict success among candidates for freshman admission. FIGS. 1 and 2 illustrate both the EDUCATION and SCREENING subcomponents.

(e) INTAKE OR FORM SUBMISSION—this subcomponent is further illustrated by FIGS. 1 and 2. They demonstrate the basic tool used for intake, i.e., the gathering of all information necessary to process the user's request and bring it to fruition, as well as the obtention of a legally-binding indication of agreement to the terms and conditions under which the use of the (Cyber)Airhitch® system is extended to the user, and of user's authorization for payment by credit card (even though the payment will not be drawn from the user's account at the time of submission of the form—a key element in the encouragement of system use for longstanding reasons related to the politico-economic behavior of the air-transport industry as a whole).

(f) ACKNOWLEDGEMENT/ADVISEMENT—this subcomponent is exemplified in the Figures. It is perhaps the most mechanical, repetitive, and standardized part of the entire Airhitching process, consisting of simple acknowledgement of receipt of the user's registration, and the advisement of the next steps necessary in the process, i.e., establishment of an Airport Support Person (ASP), and initiation of contact with the ADS for the beginning of the KB.

(g) INFO STORAGE—this subcomponent is managed by specific software applications, principally email storage and retrieval and database storage and retrieval. Classical and standard methods of info storage and retrieval are the only ones necessary, however, a highly integrated system could be used, and up to a specific, rather high volume of demand, most of this function can be handled by a SINGLE ADMINISTRATOR with the aid of software prosthesis.

(h) PRELIMINARY FLIGHT-BRIEFING—General availability overview tableau for user-specified period of time and departure/arrival regions; analysis of expressed needs of user; suggestions for further research by user of possibly necessary auxiliary travel problems contingent upon specific outcome of Airhitch® endeavor. This phase of the CyberAirhitch® process occurs at the initiation of the user, via IM.

(i) INTERMEDIATE FLIGHT-BRIEFING—Refinement of general availability overview into specific observations about specific potential availabilities; feedback on preliminary research performed by Airhitcher in terms of refinement and further specification of that research; scheduling of final flight briefing (FED). This phase of the process can be initiated either by the AOS or the user, however it often ensues “naturally”.

(j) FINAL FLIGHT-BRIEFING—Obtention of permission to collect payment by charging credit card account of Airhitcher; transmission of Airhitch® Boarding Code (ABC) to Airhitcher and/or all members of his/her party; transmission of final specific details of “where2go&what2do” to attempt boarding of the aircraft; transmission of necessary information for verification of these details; final refinement and of all advice for auxiliary travel necessary for positioning, including matching of Airhitchers for carpooling and ride sharing within their origin or destination region. This phase of the process occurs by FIXED APPOINTMENT, usually determined by flight schedules, with all Airhitchers departing on a certain day and on a certain set of flights being briefed concurrently and en masse, in an IM chatroom. This arrangement facilitates inter-assistance among Airhitchers, on such matters as ridesharing and carpooling in order to solve contingent transportation problems, if present.

(k) AIRPORT GUIDANCE—this phase of Airhitching only takes place if any problem should arise in the airport on day of flight which appears to be impeding the Airhitcher's progress onto the flight he is attempting to Airhitch® on (other than simply a shortage of seating-capacity, about which not much can be done other than to inform the passenger of the next possible Airhitchable flight opportunities. However, it must always be prepared, anticipating a worst-case scenario. It necessitates the online presence of an “Airport Support Person” (ASP) priorly selected and recruited by the Airhitcher, and in contact with the Airhitch® Online Staff (AOS) at the time the Airhitcher arrives at the terminal to begin his/her Airhitch boarding attempt.

(1) POST-FLIGHT TP-COMPENSATION—this is the only phase of Airhitching not involving the user, for by the time this phase becomes necessary, the user will have already completed his/her use of the system. However, it is of course a very necessary component of the system since TP confidence in the system would be damaged if TPs did not receive accurate and immediate compensation for having performed the carriage of the passenger.

It is to be understood that the embodiments and variations shown and described herein are merely illustrative of the principles of this invention and that various modifications may be implemented by those skilled in the art without departing from the scope and spirit of the invention.

While the present invention has been described with regards to particular embodiments, it is recognized that additional variations of the present invention may be devised without departing from the inventive concept.

What is claimed is:

1. An Internet air travel system comprising the steps of:
a. publicizing the system to a select group of travelers;
b. providing indoctrination to interested travelers of said group, with general details of and the ultimate goal of said system.
c. screening and selecting selected ones of interested travelers predicated on selected parameters and registering them for said system use;
d. establishing a constantly-updated data-base of air transportation schedules and availabilities, and users thereof, and determining probabilities of vacancy rates on airplanes flying said schedules;
e. establishing via the Internet a constantly open channel of communication between said registered users of said system and the air transportation; and
f. providing real-time data and information necessary to enable said registered user to utilize said air travel transportation system to economic advantage.

2. The system in accordance with claim 1 wherein the provisions of step (f) are effected by past users of the system.

3. The system in accordance with claim 1 wherein said publicizing communications which are accomplished through the Internet exclusively, except as specifically noted.

4. The system in accordance with claim 1 wherein agreements exist between the provider of the Internet air travel system and air-transportation providers.

5. The system in accordance with claim 1 wherein the selected ones of interested travelers are selected from the population sector consisting of including principally, but not limited to, college students and retired persons.

6. The Internet Air Travel System in accordance with claim 1 wherein the data of step (d) are initially obtained from and made available by air-transportation providers, and subsequently refined by application of past experience with various variables on the part of the staff, all of which are users of the system.

7. The Internet Air Travel System in accordance with claim 6 wherein the channel of communication of step (e) is established exclusively by means of the Internet.

8. The Internet Air Travel System in accordance with claim 7 wherein telephonic and other means are utilized with respect to providing the real time data and information of step (f) only in cases of emergency.

9. The Internet Air Travel System in accordance with claim 8 wherein said traveler is issued a one-time use number which is utilized by the airlines for billing purposes.

10. The Internet Air Travel System in accordance with claim 1 which additionally includes boarding flights, at the last possible moment before seat-perishability, that are leaving during a generic time-window, to take said traveler along a generic itinerary of benefit in conveying that traveler to or toward where said traveler wishes to go.
